(19) United States
(12) Patent Application Publication
(10) Pub. No.: US 2026/0110495 A1
(43) Pub. Date: Apr. 23, 2026

(54) HEAT EXCHANGER

(71) Applicant: Hanon Systems, Daejeon (KR)

(72) Inventor: Sung Hong SHIN, Daejeon (KR)

(73) Assignee: Hanon Systems, Daejeon (KR)

(21) Appl. No.: 19/115,221

(22) PCT Filed: Oct. 31, 2023
(86) PCT No.: PCT/KR2023/017078

§ 371 Date: Mar. 25, 2025

(30) Foreign Application Priority Data
Dec. 19, 2022 (KR) 10-2022-0177959

(51) Int. Cl. F28D 1/03; F28D 1/02; F28D 15/02; F28F 9/02

(52) U.S. Cl. CPC F28D 1/0333; F28D 15/0275; F28F 9/0256; F28D 2001/0266

(57) ABSTRACT

The present disclosure relates to a heat exchanger in which a heat exchange medium is cooled by a liquid and, more specifically, to a technology in which a condensation unit and a supercooling unit of a heat exchanger are formed as a single core, and a receiver drier is disposed adjacent to the core, so as to reduce the number of components of the heat exchanger and simplify packaging.

### TECHNICAL FIELD

The present disclosure relates to a water-cooled heat exchanger in which a heat exchange medium is cooled by liquid and, more particularly, to a technology in which a condensation unit and a supercooling unit of a heat exchanger are formed as a single core, and a receiver drier is disposed adjacent to the core, so as to reduce the number of components of the heat exchanger and simplify packaging.

### BACKGROUND ART

In general, a heat exchanger is a device designed to allow heat exchange between two or more fluids. A heat exchanger is used to allow heat exchange between different fluids for the purpose of cooling or heating a fluid, and representative applications are an automotive cooling/heating system, a refrigerator, an air conditioner, etc.

A plate type heat exchanger that is applied to an automotive cooling/heating system forms passages between plates having a predetermined thickness to allow fluids to flow, and is characterized in that multiple plates are arranged at regular intervals such that different fluids flow through alternating passages.

Referring to Korean Patent Laid-Open Publication No. 10-2020-0011163, as illustrated in FIG. 1, a water-cooled condenser 10 that is one of heat exchangers includes a condensation unit 20 in which a plurality of first plates 21 is stacked alternately multiple times and a refrigerant flows inside to be condensed, a supercooling unit 30 in which a plurality of second plates 31 is stacked alternately multiple times and a refrigerant is supercooled, a connecting plate 40 formed between the first plates 21 of the condensation unit 20 and the second plates 31 of the supercooling unit 30, and a receiver drier 50 connected with the connecting plate 40 to separate and transmit gas and liquid from the refrigerant condensed in the condensation unit 20 to the supercooling unit 30.

According to the receiver drier-integrated water-cooled condenser 10 of the related art described above, since the receiver drier 50 is positioned between the condensation unit 20 and the supercooling unit 30 through the connecting plate 40, a separate complicated component such as the connecting plate 40 is additionally required to connect the condensation unit 20 and the supercooling unit 30, and accordingly, there is a problem in that the number of parts of the water-cooled condenser 10 increases and the package increases.

### DISCLOSURE

### Technical Problem

An object of the present disclosure provides a heat exchanger in which a condensation unit and a supercooling unit of a heat exchanger are formed as a single core, and the condensation unit and the receiver drier are connected through a first connector passing through a plate of the supercooling unit such that a receiver drier is disposed adjacent to the supercooling unit.

Another object of the present disclosure provides a heat exchanger in which a supercooling unit and a discharge pipe are connected through a second connector passing through a plate of a condenser such that an intake pipe supplying a refrigerant to a condensation unit and the discharge pipe discharging a refrigerant supercooled at the supercooling unit are disposed on the same side of a core.

### Technical Solution

In one general aspect, a heat exchanger includes: a condensation unit in which a first refrigerant flow path through which a refrigerant flows and a first cooling water flow path through which cooling water flows are formed by stacking a plurality of plates and that condenses the refrigerant through heat exchange between the refrigerant and the cooling water; a receiver drier separating gas and liquid from the refrigerant condensed at the condensation unit; and a supercooling unit in which a second refrigerant flow path through which a refrigerant flows and a second cooling water flow path through which cooling water flows are formed by stacking a plurality of plates and that supercools the refrigerant through heat exchange between a refrigerant passing through the receiver drier and cooling water, in which the condensation unit and the supercooling unit are stacked and integrally formed as a single core, and the receiver drier is disposed outside the single core.

The condensation unit, the supercooling unit, and the receiver drier may be sequentially stacked in a stacking direction of the plates, and a refrigerant passing through the condensation unit bypasses the inside of the supercooling unit and may be transmitted to the receiver drier.

The heat exchanger may include: a 1-1-th connector connecting a rear end of the first refrigerant flow path and an inlet of the receiver drier; and a 1-2-th connector connecting an outlet of the receiver drier and a front end of the second refrigerant flow path.

The 1-1 connector may be connected at a front end to the first refrigerant flow path of the condensation unit and connected at a rear end to the receiver drier through the supercooling unit such that a refrigerant discharged from the condensation unit bypasses the supercooling unit.

The condensation unit may include a refrigerant intake port formed at an upper end of a side of the condensation unit to supply a refrigerant to the first refrigerant flow path, and the heat exchanger may further include a second connector connected at a front end to the second refrigerant flow path of the supercooling unit and may be connected at a rear end to a refrigerant discharge port formed at a lower end of a side of the condensation unit.

The second connector may be connected at a front end to the second refrigerant flow path of the supercooling unit and connected at a rear end to the receiver drier through the condensation unit such that a refrigerant discharged from the supercooling unit bypasses the condensation unit.

The 1-1-th connector may be brazed at the front end to the condensation unit in a burring type, and the 1-2-th connector may be brazed at a rear end to the supercooling unit in a burring type.

The 1-1-th connector may be integrally brazed at the rear end to an inlet formed at a lower side of the receiver drier in the gravity direction, and the 1-2-th connector may be integrally brazed at a front end to an outlet formed at an upper side of the receiver drier in the gravity direction.

The receiver drier may be integrally brazed to another side of the supercooling unit.

The condensation unit may include a refrigerant intake port formed at an upper end of a side of the condensation unit to supply a refrigerant to the first refrigerant flow path, and a refrigerant discharge port for discharging a refrigerant supercooled through the supercooling unit is formed at a lower end of another side of the supercooling unit.

The heat exchanger may be a plate-type heat exchanger that includes: a condensation unit in which a first refrigerant flow path and a first cooling water flow path are formed by alternately stacking one or more first plate assemblies formed by coupling a pair of 1-1-th and 1-2-th plates and one or more third plate assemblies formed by coupling a pair of 3-1-th and 3-2-th plates; and a supercooling unit in which a second refrigerant flow path and a second cooling water flow path are formed by alternately stacking one or more second plate assemblies formed by coupling a pair of 2-1-th and 2-2-th plates and one or more fourth plate assemblies formed by coupling a pair of 4-1-th and 4-2-th plates.

The 1-1-th connector may be formed through the second plate assemblies of the supercooling unit such that a refrigerant discharged from another side of the condensation unit bypasses the supercooling unit.

The 1-2-th connector may be connected at a front end to a drier outlet formed at an upper side of a longitudinal direction of the receiver drier and connected at a rear end to an upper end of another side of the second plate assemblies in a stacking direction.

The first refrigerant flow path may include: a first inflow channel formed in a stacking direction through a first inflow hole formed at an upper side of a longitudinal direction of a plurality of first plate assemblies; a first main channel formed in the longitudinal direction of the plurality of first plate assemblies; and a first outflow channel formed in a stacking direction through a first outflow hole formed at a lower side of the longitudinal direction of the plurality of first plate assemblies, and the second refrigerant flow path may include: a second inflow channel formed in the stacking direction through a first inflow hole formed at an upper side of a longitudinal direction of a plurality of second plate assemblies; a second main channel formed in the longitudinal direction of the plurality of second plate assemblies; and a second outflow channel formed in a stacking direction through a second outflow hole formed at a lower side of the longitudinal direction of the plurality of second plate assemblies.

The heat exchanger may include a separation plate assembly provided between a first plate assembly disposed at an end of another side of the condensation unit and a second plate assembly disposed at an end of a side of the supercooling unit, in which the separation plate assembly may have the same external shape and size as the first and second plate assemblies and blocks refrigerants to prevent a refrigerant of the condensation unit or a refrigerant of the supercooling unit from flowing inside, and a cooling water flow space may be formed in the heat exchanger such that the first cooling water flow path of the condensation unit and the second cooling water flow path of the supercooling unit are connected to each other.

### Advantageous Effects

According to the heat exchanger of the present disclosure by the configuration described above, the condensation unit and the supercooling unit are formed as a single core, and the condensation unit and the receiver drier, and the receiver drier and the supercooling unit are connected using connectors that are simple connecting members, so there is an effect that reduces the number of parts and simplifying packaging of the heat exchanger.

Further, an inflow pipe supplying a refrigerant to the condensation unit and a discharge pipe discharging a refrigerant supercooled at the supercooling unit are disposed on the same side of the core, so there is an effect that ensures space for an engine room of a vehicle and improves convenience of assembly.

### BRIEF DESCRIPTION OF THE DRAWINGS

FIG. 1 is an exploded perspective view of a heat exchanger of the related art.

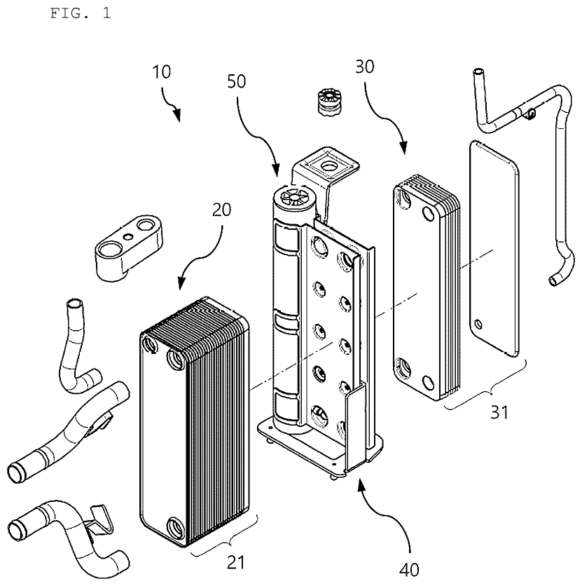

FIG. 2 is a perspective view of a heat exchanger according to an embodiment of the present disclosure.

FIG. 3 is a front view of the heat exchanger according to an embodiment of the present disclosure.

FIG. 4 is a schematic partially enlarged cross-sectional view of the heat exchange, illustrating the coupling structure of a condensation unit and a supercooling unit according to an embodiment of the present disclosure.

FIG. 5 is a schematic cross-sectional view illustrating flow of a refrigerant in a heat exchanger according to a first embodiment of the present disclosure.

FIG. 6 is a schematic cross-sectional view illustrating flow of a refrigerant in a heat exchanger according to a second embodiment of the present disclosure.

### DESCRIPTION OF REFERENCE NUMERALS

100: Heat exchanger
101: First plate assembly
102: Second plate assembly
103: Third plate assembly
104: Fourth plate assembly
105: Separation plate assembly
110: Condensation unit
111: First inflow channel
112: First outflow channel
120: Supercooling unit
121: Second inflow channel
122: Second outflow channel
131: Refrigerant intake port
132: Refrigerant discharge port
141: Cooling water intake port
142: Cooling water discharge port
150: Receiver drier
160: 1-1-th connector
170: 1-2-th connector
180: Second connector

### BEST MODE

Hereinafter, the present disclosure is described in more detail with reference to the accompanying drawings. The embodiments to be introduced below are provided as examples so that the spirit of the present disclosure can be sufficiently communicated to those skilled in the art. The present disclosure is not limited to the embodiments to be described below and may be implemented in other ways.

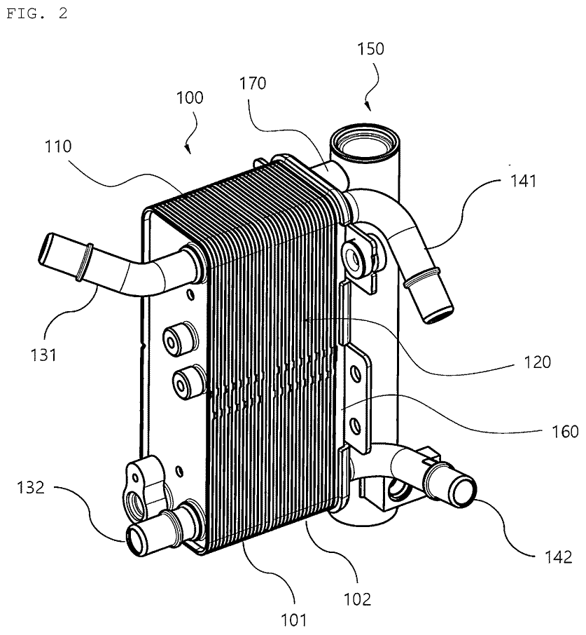

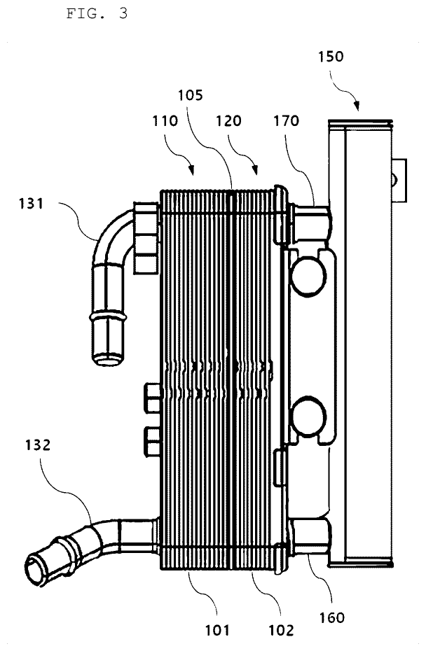

FIG. 2 is a perspective view of a heat exchanger 100 according to an embodiment of the present disclosure and FIG. 3 is a front view of the heat exchanger 100 according to an embodiment of the present disclosure.

As illustrated in the drawings, the heat exchanger 100 includes: a condensation unit 110 in which a first refrigerant flow path and a first cooling water flow path are alternately formed by stacking multiple times a plurality of first plate assemblies 101 formed by coupling a pair of 1-1-th and 1-2-th plates to form a refrigerant flow path and a cooling water flow path and a refrigerant flows into the first cooling water flow path and is condensed by exchanging heat with cooling water flowing into the first cooling water flow path; a supercooling unit 120 in which a second refrigerant flow path and a second cooling water flow path are alternately formed by stacking multiple times a plurality of second plate assemblies 102 formed by coupling a pair of 2-1-th and 2-2-th plates and a refrigerant flows into the second cooling water flow path and is supercooled by exchanging heat with cooling water flowing into the second cooling water flow path; and a receiver drier 150 separating and transmitting gas and liquid from the refrigerant condensed at the condensation unit 110 to the supercooling unit 120.

Further, the heat exchanger 100 includes a refrigerant intake port 131 formed at the upper portion on a side of the condensation unit 110 in the stacking direction to receive a refrigerant into the first refrigerant flow path of the condensation unit 110 and a cooling water intake port 141 formed at the upper portion on another side of the supercooling unit 120 in the stacking direction to receive cooling water into the first cooling water flow path of the condensation unit 110.

Further, the heat exchanger 100 includes a refrigerant discharge port 132 formed at the lower portion on a side of the condensation unit 110 in the stacking direction to discharge a refrigerant supercooled through the second refrigerant flow path of the supercooling unit 120, and a cooling water discharge port 142 formed at the lower portion on another side of the supercooling unit 120 in the stacking direction to discharge cooling water that has exchanged heat with a refrigerant through the second cooling water flow path of the supercooling unit 120.

In this case, the heat exchanger 100 of the present disclosure is characterized by being configured in a single core type in which the supercooling unit 120 is integrally formed on another side of the condensation unit 110 in the stacking direction. For this purpose, a separation plate assembly 105 may be provided between a first plate assembly 101 of the condensation unit 110 and a second plate assembly 102 of the supercooling unit 120. The separation plate assembly 105 is formed in the same shape as the first and second plate assemblies 101, blocks refrigerants to prevent a refrigerant of the condensation unit 110 or a refrigerant the supercooling unit 120 from flowing inside, has a cooling water flow space formed to enable cooling water of the condensation unit 110 and cooling water of the supercooling unit 120 to flow to each other, and may be configured such that the cooling water flow space of the condensation unit 110 and the cooling water flow space of the supercooling unit 120 are connected to each other. The detailed configuration of the separation plate assembly 105 will be described with reference to drawings.

Further, the receiver drier 150 may be disposed adjacent to another side of the supercooling unit 120. In more detail, the receiver drier 150 may be integrally brazed to another side of the supercooling unit 120. For this purpose, the heat exchanger 100 includes a 1-1-th connector 160 connecting the rear end of the first refrigerant flow path and the inlet of the receiver drier 150, and a 1-2-th connector 170 connecting an outlet of the receiver drier 150 and the front end of the second refrigerant flow path of the supercooling unit 120. In this case, the 1-1-th connector 160 is formed to penetrate the second plate assembly 102 of the supercooling unit 120 such that a refrigerant discharged from another side of the condensation unit 110 bypasses the supercooling unit 120. Further, the 1-1-th connector 160 is connected at the front end to the lower side in the longitudinal direction of the condensation unit 110 and is connected at the rear end to a drier inlet formed at the lower side in the longitudinal direction of the receiver drier 150. Further, the 1-2-th connector 170 is connected at the front end to a drier outlet formed at an upper side in the longitudinal direction of the receiver drier 150 and is connected at the rear end to the upper side in the longitudinal direction of the supercooling unit 120.

Through the configuration described above, a refrigerant supplied to the refrigerant intake port 131 flows into the receiver drier 150 through the 1-1-th connector 160 after passing through the first refrigerant flow path of the condensation unit 110, and a refrigerant separated into gas and liquid through the receiver drier 150 is discharged to the refrigerant discharge port 132 after passing through the second refrigerant flow path of the supercooling unit 120 through the 1-2-th connector 170.

Hereafter, the detailed configuration and the flow paths of the heat exchanger 100 of the present disclosure having the characteristics described above are described in detail with reference to drawings.

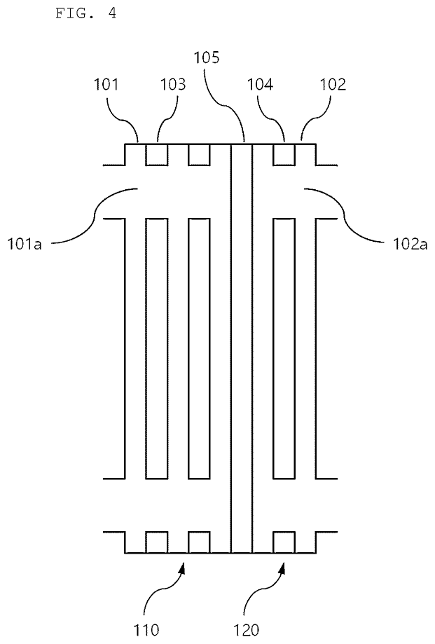

In FIG. 4, a partial enlarged schematic cross-sectional view of the heat exchanger 100 that illustrates the coupling structure of the condensation unit 110 and the supercooling unit 120 through the separation plate assembly 105 of the heat exchanger 100 in an integrally formed single core type according to an embodiment of the present disclosure is illustrated.

As illustrated in the drawing, in the condensation unit 110, first plate assemblies 101 in which a refrigerant flows and third plate assemblies 103 in which cooling water flows may be alternately stacked. In this case, the first plate assemblies 101 have a first connection hole 101a to be connected with adjacent first plate assemblies 101 through the third plate assemblies 103. Accordingly, a refrigerant of a first plate assembly 101 flows to an adjacent first plate assembly 101 through the first connection hole 101a. Further, the third plate assemblies 103 have a third connection hole (not illustrated) to be connected with adjacent third plate assemblies 103 through the first plate assemblies 101. Accordingly, cooling water of a third plate assembly 103 flows to an adjacent third plate assembly 103 through the third connection hole.

Further, in the supercooling unit 120, second plate assemblies 102 in which a refrigerant flows and fourth plate assemblies 104 in which cooling water flows may be alternately stacked. In this case, the second plate assemblies 102 have a second connection hole 102a to be connected with adjacent second plate assemblies 102 through the fourth plate assemblies 104. Accordingly, a refrigerant of a second plate assembly 102 flows to an adjacent second plate assembly 102 through the second connection hole 102a. Further, the fourth plate assemblies 104 have a fourth connection hole (not illustrated) to be connected with adjacent fourth plate assemblies 104 through the second plate assemblies 102. Accordingly, cooling water of a fourth plate assembly 104 flows to an adjacent fourth plate assembly 104 through the fourth connection hole.

In this case, the first plate assemblies 101 are disposed at another end of the condensation unit 110 in the stacking direction, the second plate assemblies 102 are disposed at an end of a side of the supercooling unit 120 in the stacking direction, and the separation plate assembly 105 is provided between them, so they can be stacked and coupled to each other. The separation plate assembly 105 may be formed in the same shape as the first plate assemblies 101 and the second plate assemblies 102, and may have a cooling water flow space formed therein. Accordingly, the separation plate assembly 105 may be configured to prevent a refrigerant of the condensation unit 110 from flowing to the supercooling unit 120 and allow only cooling water to flow.

In more detail, the separation plate assembly 105 may have a 3-1-th connection hole (not illustrated) formed on a side and passing through the first plate assemblies 101 to be connected with the third plate assemblies 103 of the adjacent condensation unit 110, and a 3-2-th connection hole (not illustrated) formed on another side and passing through the second plate assemblies 102 to be connected with the fourth plate assemblies 104 of the adjacent supercooling unit 120. Accordingly, cooling water flowing in the condensation unit 110 can flow to the supercooling unit 120 through the separation plate assembly 105 or cooling water flowing in the supercooling unit 120 can flow to the condensation unit 110 through the separation plate assembly 105.

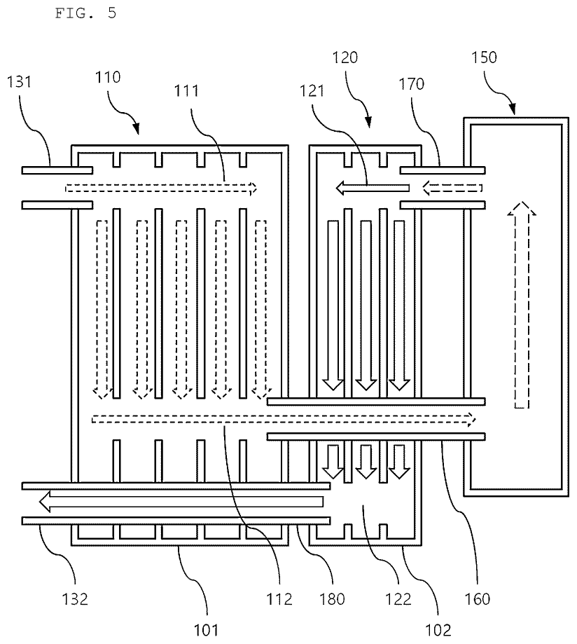

A schematic cross-sectional view illustrating flow of a refrigerant in the heat exchanger 100 according to the first embodiment of the present disclosure is illustrated in FIG. 5. In the heat exchanger 100, a third plate assembly 103 (see FIG. 4) in which cooling water flows is provided between a first plate assembly 101 and an adjacent first plate assembly 101, and a fourth plate assembly 104 (see FIG. 4) in which cooling water flows is provided between a second plate assembly 102 and an adjacent second plate assembly 102, but the heat exchanger is described without the configuration of the third and fourth plate assemblies 103 and 104 in which cooling water flows for easier understanding of the flow of a refrigerant.

As illustrated in the drawing, as the first refrigerant flow path, a first inflow channel 111 formed through a first inflow hole formed at the upper side of the longitudinal direction of the plurality of first plate assemblies 101 is formed in the stacking direction. Accordingly, a refrigerant flowing into the first refrigerant intake port 131 flows into the plurality of first plate assemblies 101 along the first inflow channel 111 and flows down in the longitudinal direction of the plurality of first plate assemblies 101.

Further, as the first refrigerant flow path, a first outflow channel 112 formed through a first outflow hole formed at the lower side of the longitudinal direction of the plurality of first plate assemblies 101 is formed in the stacking direction. Accordingly, a refrigerant flowing to the lower side of the longitudinal direction of the plurality of first plate assemblies 101 flows to another side of the condensation unit 110 in the stacking direction along the first outflow channel 112.

In this case, the heat exchanger 100 of the present disclosure includes a 1-1-th connector 160 connected at the front end to the lower end of another side of the condensation unit 110 in the stacking direction and connected at the rear end to the drier inlet formed at the lower side in the longitudinal direction of the receiver drier 150. In particular, the 1-1-th connector 160 may be formed through the lower side of the longitudinal direction of the second plate assemblies 102 such that a refrigerant flowing into the front end bypasses the supercooling unit 120. Accordingly, a refrigerant flowing down in the longitudinal direction of the condensation unit 110 flows to the lower end of the receiver drier 150 through the first outflow channel 112 and the 1-1-th connector 160 and moves upper side of the longitudinal direction of the receiver drier 150, and gas and liquid are removed in this process.

Further, the heat exchanger 100 of the present disclosure includes a 1-2-th connector 170 connected at the front end to a drier outlet formed at an upper side in the longitudinal direction of the receiver drier 150 and connected at the rear end to the upper end of another side of the supercooling unit 120 in the stacking direction. Accordingly, a refrigerant flowing to the upper side of the receiver drier 150 flows into the upper portion of another side of the supercooling unit 120 in the stacking direction through the 1-2-th connector 170.

Meanwhile, as the second refrigerant flow path, a second inflow channel 121 formed through a second inflow hole formed at the upper side of the longitudinal direction of the plurality of second plate assemblies 102 is formed in the stacking direction. Accordingly, a refrigerant discharged from the 1-2-th connector 170 flows into the plurality of second plate assemblies 102 along the second inflow channel 121 and flows to the lower side of the longitudinal direction of the plurality of second plate assemblies 102.

Further, as the second refrigerant flow path, a second outflow channel 122 formed through a second outflow hole formed at the lower side of the longitudinal direction of the plurality of second plate assemblies 102 is formed in the stacking direction. Accordingly, a refrigerant flowing to the lower side of the longitudinal direction of the plurality of second plate assemblies 102 flows to a side of the supercooling unit 120 in the stacking direction along the first outflow channel 122.

In this case, the heat exchanger 100 of the present disclosure includes a second connector 180 connected at the front end to the lower end of a side of the supercooling unit 120 in the stacking direction and connected at the rear end to the refrigerant discharge port 132 formed at the lower end of a side of the condensation unit 110 in the stacking direction. In particular, the second connector 180 may be formed through the lower side of the longitudinal direction of the first plate assemblies 101 such that a refrigerant flowing into the front end bypasses the condensation unit 110. Accordingly, a refrigerant flowing to the lower side of the longitudinal direction of the supercooling unit 120 moves to the refrigerant discharge port 132 through the second outflow channel 122 and the second connector 180 and is then discharged outside.

The heat exchanger 100 according to the first embodiment of the present disclosure having the configuration described above is configured such that the refrigerant intake port supplying a refrigerant to the condensation unit 110 and the refrigerant discharge port discharging a refrigerant supercooled at the supercooling unit 120 are both disposed on a side of the condensation unit 110 in the stacking direction, so when it is installed in a vehicle, it is easy to ensure a space for an engine room and improve convenience of assembly with other parts.

Meanwhile, the front end of the 1-1-th connector 160 may be brazed to the first plate assembly 101 in a burring type for sealing with the condensation unit 110. Further, the rear end of the 1-2-th connector 170 may also be brazed to the second plate assembly 102 in a burring type for sealing with the supercooling unit 120. Further, the front end of the second connector 180 may be brazed to the second plate assembly 102 in a burring type for sealing with the supercooling unit 120.

Further, the receiver drier 150 may be brazed after the condensation unit 110 and the supercooling unit 120 are assembled in a state in which the receiver drier is integrally sub-assembled with anther side of the second plate assembly 102, the rear end of the 1-1-th connector 160, and the front end of the 1-2-th connector 170.

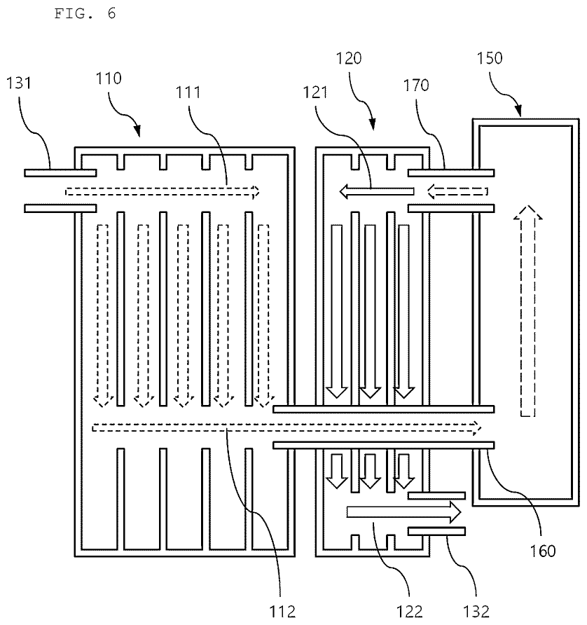

A schematic cross-sectional view illustrating flow of a refrigerant in the heat exchanger 100 according to the second embodiment of the present disclosure is illustrated in FIG. 6.

The heat exchanger 100 according to the second embodiment of the present disclosure is different from the heat exchanger 100 according to the first embodiment in that the second connector 180 of the heat exchanger 100 according to the first embodiment described above is removed and the disposition of the refrigerant discharge port 132 is different, SO the configuration different from the heat exchanger 100 according to the first embodiment is described hereafter. In the heat exchanger 100, a third plate assembly 103 (see FIG. 4) in which cooling water flows is provided between a first plate assembly 101 and an adjacent first plate assembly 101, and a fourth plate assembly 104 (see FIG. 4) in which cooling water flows is provided between a second plate assembly 102 and an adjacent second plate assembly 102, but the heat exchanger is described without the configuration of the third and fourth plate assemblies 103 and 104 in which cooling water flows for easier understanding of the flow of a refrigerant.

In the heat exchanger 100 according to the second embodiment of the present disclosure, the refrigerant discharge port 132 for discharging a refrigerant supercooled through the supercooling unit 120 may be formed at the lower end of another side of the supercooling unit 120 in the stacking direction.

Accordingly, a refrigerant flowing to the lower side of the longitudinal direction of the supercooling unit 120 moves to the refrigerant discharge port 132 formed at the lower end of another side of the supercooling unit 120 in the stacking direction along the second outflow channel 122 and is then discharged outside.

The heat exchanger 100 according to the second embodiment of the present disclosure described above is different from the heat exchanger 100 according to the first embodiment described above in that the refrigerant intake port 131 and the refrigerant discharge port 132 are formed on a side of the condensation unit 110 in the stacking direction and on another side of the supercooling unit 120 in the stacking direction, respectively, but there is no need for a second connector, so there is an effect that it is possible to reduce the number of parts in comparison with the first embodiment.

The spirit of the present disclosure should not be construed as being limited to the embodiments described above. The application range is various and the present disclosure may be modified in various ways by those skilled in the art without departing from the scope of the present disclosure described in claims. Accordingly, such modifications and changes are included in the protective range of the present disclosure that is apparent to those skilled in the art.

1. A heat exchanger comprising:
a condensation unit in which a first refrigerant flow path through which a refrigerant flows and a first cooling water flow path through which cooling water flows are formed by stacking a plurality of plates and that condenses the refrigerant through heat exchange between the refrigerant and the cooling water;
a receiver drier separating gas and liquid from the refrigerant condensed at the condensation unit; and
a supercooling unit in which a second refrigerant flow path through which a refrigerant flows and a second cooling water flow path through which cooling water flows are formed by stacking a plurality of plates and that supercools the refrigerant through heat exchange between a refrigerant passing through the receiver drier and cooling water,
wherein the condensation unit and the supercooling unit are stacked and integrally formed as a single core, and the receiver drier is disposed outside the single core.

2. The heat exchanger of claim 1, wherein the condensation unit, the supercooling unit, and the receiver drier are sequentially stacked in a stacking direction of the plates.

3. The heat exchanger of claim 2, wherein a refrigerant passing through the condensation unit bypasses the inside of the supercooling unit and is transmitted to the receiver drier.

4. The heat exchanger of claim 1, wherein the heat exchange includes:
a 1-1-th connector connecting a rear end of the first refrigerant flow path and an inlet of the receiver drier; and
a 1-2-th connector connecting an outlet of the receiver drier and a front end of the second refrigerant flow path.

5. The heat exchanger of claim 4, wherein the 1-1 connector is connected at a front end to the first refrigerant flow path of the condensation unit and is connected at a rear end to the receiver drier through the supercooling unit such that a refrigerant discharged from the condensation unit bypasses the supercooling unit.

6. The heat exchanger of claim 5, wherein the condensation unit includes a refrigerant intake port formed at an upper end of a side of the condensation unit to supply a refrigerant to the first refrigerant flow path, and
the heat exchanger further includes a second connector connected at a front end to the second refrigerant flow path of the supercooling unit and is connected at a rear end to a refrigerant discharge port formed at a lower end of a side of the condensation unit.

7. The heat exchanger of claim 6, wherein the second connector is connected at a front end to the second refrigerant flow path of the supercooling unit and is connected at a rear end to the receiver drier through the condensation unit such that a refrigerant discharged from the supercooling unit bypasses the condensation unit.

8. The heat exchanger of claim 4, wherein the 1-1-th connector is brazed at the front end to the condensation unit in a burring type, and
the 1-2-th connector is brazed at a rear end to the supercooling unit in a burring type.

9. The heat exchanger of claim 8, wherein the 1-1-th connector is integrally brazed at the rear end to an inlet formed at a lower side of the receiver drier in the gravity direction, and
the 1-2-th connector is integrally brazed at a front end to an outlet formed at an upper side of the receiver drier in the gravity direction.

10. The heat exchanger of claim 4, wherein the receiver drier is integrally brazed to another side of the supercooling unit.

11. The heat exchanger of claim 5, wherein the condensation unit includes a refrigerant intake port formed at an upper end of a side of the condensation unit to supply a refrigerant to the first refrigerant flow path, and
a refrigerant discharge port for discharging a refrigerant supercooled through the supercooling unit is formed at a lower end of another side of the supercooling unit.

12. The heat exchanger of claim 4, wherein the heat exchange is a plate-type heat exchanger that includes:
a condensation unit in which a first refrigerant flow path and a first cooling water flow path are formed by alternately stacking one or more first plate assemblies formed by coupling a pair of 1-1-th and 1-2-th plates and one or more third plate assemblies formed by coupling a pair of 3-1-th and 3-2-th plates; and
a supercooling unit in which a second refrigerant flow path and a second cooling water flow path are formed by alternately stacking one or more second plate assemblies formed by coupling a pair of 2-1-th and 2-2-th plates and one or more fourth plate assemblies formed by coupling a pair of 4-1-th and 4-2-th plates.

13. The heat exchanger of claim 12, wherein the 1-1-th connector is formed through the second plate assemblies of the supercooling unit such that a refrigerant discharged from another side of the condensation unit bypasses the supercooling unit.

14. The heat exchanger of claim 13, wherein the 1-2-th connector is connected at a front end to a drier outlet formed at an upper side of a longitudinal direction of the receiver drier and is connected at a rear end to an upper end of another side of the second plate assemblies in a stacking direction.

15. The heat exchanger of claim 12, wherein the first refrigerant flow path includes:
a first inflow channel formed in a stacking direction through first inflow hole formed at an upper side of a longitudinal direction of a plurality of first plate assemblies;
a first main channel formed in the longitudinal direction of the plurality of first plate assemblies; and
a first outflow channel formed in a stacking direction through a first outflow hole formed at a lower side of the longitudinal direction of the plurality of first plate assemblies, and
the second refrigerant flow path includes:
a second inflow channel formed in the stacking direction through a first inflow hole formed at an upper side of a longitudinal direction of a plurality of second plate assemblies;
a second main channel formed in the longitudinal direction of the plurality of second plate assemblies; and
a second outflow channel formed in a stacking direction through a second outflow hole formed at a lower side of the longitudinal direction of the plurality of second plate assemblies.

16. The heat exchanger of claim 12, comprising:
a separation plate assembly provided between a first plate assembly disposed at an end of another side of the condensation unit and a second plate assembly disposed at an end of a side of the supercooling unit,
wherein the separation plate assembly has the same external shape and size as the first and second plate assemblies and blocks refrigerants to prevent a refrigerant of the condensation unit or a refrigerant of the supercooling unit from flowing inside, and
a cooling water flow space is formed in the heat exchanger such that the first cooling water flow path of the condensation unit and the second cooling water flow path of the supercooling unit are connected to each other.
